(19) United States
(12) Patent Application Publication
(10) Pub. No.: US 2005/0154921 A1
(43) Pub. Date: Jul. 14, 2005

(54) Method and apparatus for providing a security profile

(75) Inventor: Alexander Medvinsky, San Diego, CA (US)

Correspondence Address: MOSER, PATTERSON & SHERIDAN L.L.P., 595 SHREWSBURY AVE, STE 100, FIRST FLOOR, SHREWSBURY, NJ, 07702, US

(73) Assignee: General Instruments Corporation

(21) Appl. No.: 11/032,461

(22) Filed: Jan. 10, 2005

Related U.S. Application Data
(60) Provisional application No. 60/535,339, filed on Jan. 9, 2004.

(51) Int. Cl. H04L 9/00

(52) U.S. Cl. 713/201

(57) ABSTRACT

The present invention discloses an apparatus and method for providing a security profile that defines a separate security level for each security component within a client device. A client device may employ a plurality of security components or functions, e.g., a key/certificate management component, a content encryption/decryption component, a secure clock component, a secure time of day component, a content decoding component, a content encoding component, and the like. Therefore, rather than forcing all client devices to have the same level of security, each security component within the client device can have a different security level. Therefore, depending on the specific content, a device may or may not qualify to receive it or render it, based on its security level of each security component and not just based on the security level of the entire client device.

### CROSS-REFERENCE TO RELATED APPLICATION

This application claims the benefit of U.S. Provisional Application No. 60/535,339, filed on Jan. 9, 2004, which is herein incorporated by reference.

### BACKGROUND OF THE INVENTION

1. Field of the Invention

Embodiments of the present invention generally relate to digital rights management (DRM). More specifically, the present invention relates to a method and apparatus for providing a security profile that defines a separate security level for each security component within a client device.

2. Description of the Related Art

Digital contents have gained wide acceptance in the public. As such, many consumers and businesses have digital media systems that enable the reception of such digital contents via various communication channels, e.g., via a wireless link such as a satellite link or a wired link such as cable connections and/or telephony based connections such as DSL and the like.

Irrespective of the communication channels that are employed to receive the digital contents, owners of contents and the service providers (e.g., a cable service provider, a telecommunication service provider, a satellite-based service provider) who provide such contents to subscribers are concerned with the protection of such digital contents. To illustrate, in the area of digital rights management and conditional access, the physical security of a client device is an important part of the overall system security. If a client device is compromised, its keys could be extracted and copied out to other devices that will be able to illegally receive content services, e.g., a movie, a video, a song and the like. Alternatively, a client device could be compromised in order to circumvent the checking of DRM rules. For example, a movie file could be downloaded over the Internet based on a rental agreement, where DRM rules may dictate that access to the movie is due to expire in one (1) week. A compromised client device could circumvent the checking and/or enforcement of DRM rules, thereby allowing access to the movie beyond the agreed terms. In fact, the movie can even be distributed illegally. Therefore, in addition to cryptographic protocols, high value content may require a higher level of tamper resistance safeguards that are implemented in client devices, e.g., implementing hardware security techniques. Certainly, client devices can be designed and manufactured with such higher level of tamper resistance safeguards. But at the same time, there might be lower-value content that is for example paid for by commercials that does not require a high level of physical security. Having such a high level of security for receiving such lower-value content may not be practical or economical.

Thus, there is a need in the art for a method and apparatus for providing a security profile that defines a separate security level for each security component within a client device.

### SUMMARY OF THE INVENTION

In one embodiment, the present invention discloses an apparatus and method for providing a security profile that defines a separate security level for each security component within a client device. A client device may employ a plurality of security components or functions, e.g., a key/certificate management component, a content encryption/decryption component, a secure clock component, a secure time of day component, a content decoding component, a content encoding component, and the like. Therefore, rather than forcing all client devices to have the same level of security, each security component within the client device can have a different security level. Therefore, depending on the specific content, a device may or may not qualify to receive it or render it, based on its security level of each security component and not just based on the security level of the entire client device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a high level view of a digital content distribution system of the present invention;

FIG. 2 illustrates a method for providing a security profile that defines a separate security level for each security component within a client device in accordance with the present invention; and

FIG. 3 illustrates the present invention implemented using a general purpose computer.

To facilitate understanding, identical reference numerals have been used, wherever possible, to designate identical elements that are common to the figures.

### DETAILED DESCRIPTION OF THE PREFERRED EMBODIMENT

In one embodiment of the present invention, Digital Rights Management (DRM) may specify one or more usage rules and/or conditional access pertaining to digital contents (e.g., movies, videos, music, software applications and the like) that have been downloaded and/or stored locally by users, e.g., stored on a hard drive of a client device. The client device can be defined broadly as any device that is capable of receiving the digital content, e.g., a receiver, a set top box, an MP3 player and the like. Various security components within the client device can be tasked with the verification and/or enforcement of the usage rules or conditional access. Generally, a particular security level can be assigned and implemented for the entire client device. However, this approach does not provide the flexibility to address security requirements that may vary widely depending on the content that is being downloaded.

To address this criticality, the present invention discloses an apparatus and method for providing a security profile that defines a separate security level for each security component within a client device. A client device may employ a plurality of security components or functions, e.g., a key/certificate management component, a content encryption/decryption component, a secure clock component, a secure time of day component, a content decoding component, a content encoding component, and the like. Therefore, rather than forcing all client devices to have the same level of security, each security component within the client device can have a different security level. Therefore, depending on the specific content, a device may or may not qualify to receive it or render it, based on its security level of each security component and not just based on the security level of the entire client device.

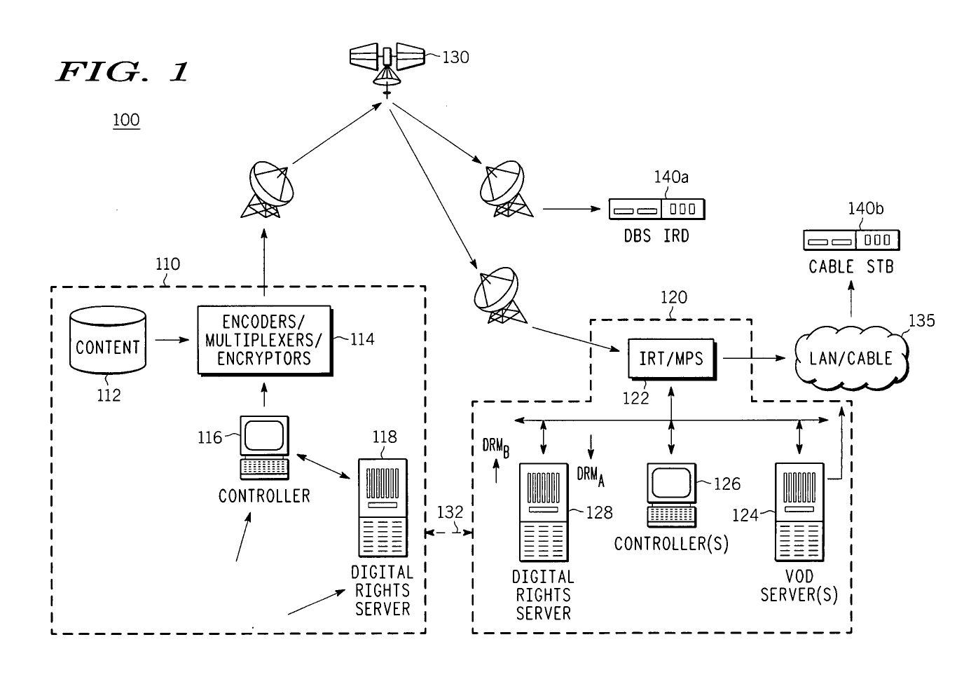

FIG. 1 illustrates a high level view of a digital content distribution system 100 of the present invention. System 100 comprises a content provider 110, a service provider 120, a satellite transmission channel 130, an access network 135 and a plurality of subscriber devices 140a and 140b.

In one illustrative embodiment, the content provider 110 (e.g., a content source) comprises a plurality of digital content 112, a plurality of encoders, multiplexers, encryptors 114, a controller 116 and a digital rights server (DRS) 118. Those skilled in the art will realize that the content provider 110 may implement additional components that are not shown in FIG. 1 to effect the transmission of multimedia contents.

In operation, DRS 118 provides digital rights control message (DRCM) to the controller 116. The digital rights control message may contain various rules pertaining to the protection of the digital contents that will be downloaded by subscribers. In one embodiment, rules of usage of the digital contents are included in the digital rights control message.

The controller 116 in accordance with the DRCM will cause contents 112 to be retrieved and processed into packets for transmission over a satellite communication channel 130. The processing may embody the usage of an encoder, an encryptor and/or a multiplexer with well known algorithms.

FIG. 1 illustrates two different scenarios where a subscriber receiving device 140a will receive the packets directly from the content provider 110 or a service provider 120 (e.g., also viewed broadly as a content source) will receive the packets directly from the content provider 110. In one embodiment, the subscriber receiving device (or broadly a client device) 140a can be situated at a consumer residence, whereas service provider 120 can be a cable company. It should be noted that the subscriber receiving device is broadly defined to be any device that has the ability to receive the digital content.

In the first scenario, content provider may have a direct relationship with a subscriber. As such, the packetized content is directly received by a subscriber device 140a, e.g., a direct broadcast system (DBS) receiver.

In the second scenario, the content provider 110 may have a direct relationship with a service provider 120, e.g., a cable company. As such, the packetized content is directly received by the service provider instead of a subscriber. In fact, although a wireless communication 130 is illustrated, a wired communication channel 132 can be used to forward content from the content provider 110 to the service provider 120. The service provider 120, in turn, may comprise an integrated receiver transcoder (IRT) and/or a modular processing system (MPS) 122, a video on demand (VOD) server 124, a controller 126, and a digital rights server 128. The received packetized multimedia is received by the integrated receiver transcoder (IRT) and/or a modular processing system (MPS) 122 which can be used to multiplex the packetized content with other services. These other services can be implemented under the control of controller 126, digital rights server 128 and VOD server 124.

To illustrate, the content provider 110 may be a film studio or a content clearing house that is sending protected content for distribution by the service provider 120 to its subscribers. As such, the service provider 120 may implement additional digital rights management requirements on top of the requirements demanded by the content provider 110. Alternatively, the service provider 120 may be tasked by the content provider 110 to implement jointly agreed digital rights management requirements, so that the content provider is only tasked with sending the protected contents to the service provider.

Alternatively, the provider 110 may represent a satellite service provider, who takes content from various content providers, and aggregates it for distribution. In one embodiment, the satellite provider is still required to obey and convey the rules defined for the content by the content provider.

In one embodiment, the service provider will use an access network 135, e.g., a LAN, a cable network, a DSL network and the like, to send the digital contents to the subscribers. In one embodiment, the subscriber receiving device 140b is a cable set top box, a receiver, an MP3 player and the like. The subscriber device 140b will have a security device that is capable of enforcing rules of usage or conditional access for the contents as defined by the service provider.

It should be noted that the term content source is broadly defined to include any entities and/or devices that have capability to forward contents that require protection, e.g., with associated DRM rules and/or conditional access. Thus, even the subscriber receiving devices 104a and 140b can be perceived as a content source if there are other devices that will receive the content from the subscriber receiving device, e.g., in a user's home environment where there are multiple devices that can receive the content.

In one embodiment of the present invention, device security functions are classified as a list of security components. Depending on the content that is being received by a client device, one or more of these security functions may be needed to process the received content. Table 1 below provides an exemplary listing of security components with a brief description for each security component. Table 1 also provides examples as to when security level of each component needs to be checked to verify and/or enforce DRM rules and/or conditional access. It should be noted that security components of Table 1 are provided only as an example and should not be interpreted as a limitation of the present invention. Any number of security components can be implemented in a client device as required for a particular implementation. In fact, the security components as listed in Table 1 can be merged or divided as required for a particular implementation.

TABLE 1

| | | | When security level |
|---|---|---|---|
| | | | of this component |
| | Security | | needs to be |
| | Component | Description | checked? |
| 1 | Key | Implementation of the key management, | Always |
| | Management | certificate validation, evaluation and | |
| | and DRM | enforcement of DRM. | |
| | Enforcement | | |
| 2 | Content | Decryption and re-encryption of the content | When content is |
| | encryption/decryption | (using a specific algorithm). The same device | decrypted (e.g., during |
| | | certificate might specify multiple encryption | rendering) or re- |
| | | algorithms at different security levels. | encrypted. |
| 3 | Secure | Implementation of a local timer. This security | For time-limited |
| | Clock | component can be implemented separately or | playbacks. |
| | | is included as part of the Secure Time of Day | |
| | | component. | |
| 4 | Secure Time | Implementation of an authenticated time | For persistent content |
| | Of Day | delivery protocol as well as updates to the | that can expire, as well |
| | | time-of-day based on a local timer. | as for time-limited |
| | | | playbacks. |
| 5 | Content | Decompression of the content. This | Before performing |
| | decoding | component has to specify a particular | digital content |
| | | decompression algorithm. The same device | decompression, e.g., |
| | | certificate might specify multiple | for the purpose of |
| | | decompression algorithms at different security | rendering or exporting |
| | | levels. This security component is used to | the content to an |
| | | prevent access to clear compressed content | analog or digital |
| | | outside the secure environment. | uncompressed |
| | | | interface. |
| 6 | Content | Compression of the content. This component | This applies for a |
| | encoding | has to specify a particular compression | device within the home |
| | | algorithm. The same device certificate might | that has to transcode |
| | | specify multiple compression and | the content using a |
| | | decompression algorithms at different security | different compression |
| | | levels. This security component is used to | algorithm. |
| | | prevent access to clear compressed content | |
| | | outside the secure environment. After content | |
| | | is compressed, it is encrypted (using another | |
| | | security component) before being released | |
| | | outside the secure environment. | |

In Table 1, the first security component is “Key Management and DRM enforcement (or Rights Management Protection Information (RMPI) Enforcement). This security component prevents illegal extraction and sharing of higher-level keys between devices. Thus, it prevents threats where one device impersonates another device in order to illegally decrypt and render content. This security component may also include rights evaluation and enforcement.

In one embodiment, content decryption/encryption is listed as a separate component because the same client device could have different security levels associated with different encryption algorithms (e.g., Triple Data Encryption Standard (3-DES) is implemented in hardware, whereas Advanced Encryption Standard (AES) is in software). Furthermore, if content is not re-encrypted after being received into a user's home domain (e.g., original broadcast keys are preserved), there is no need to check the security level of the decryption component until the content is about to be rendered, which could be performed on a different device.

It should be noted that the enforcement of the content rights only applies to those rules that are supported by the particular client device. For example, if a client device has no external digital outputs, then it can ignore any rights associated with those outputs.

In one embodiment, certain client devices may not need to implement various content rights enforcements. To illustrate, an output device, e.g., a digital TV with no storage capabilities may comply with the security level for the “Enforcement of Content Rights/Content encryption/decryption” component without implementing any content rights enforcement, since this device is only capable of one-time rendering. However, if such device provides any expansion capability for additional functionality, e.g., an option to add a hardware module with persistent storage, then the additional functionality must preserve the same security level as required by the pertinent DRM rules.

For example, when a hard disk is added to a client device, the client device must then be capable of evaluating the security level associated with a secure clock. If this client device does not support a secure clock at a sufficiently high security level as dictated by the DRM rules, then the client device must refuse to play back the content.

Several security components listed in Table 1 may be limited only to specific algorithms. For example, a client device could have a security chip that can perform AES decryption of content (e.g., a security level 3). The same client device can perform decryption using many other algorithms as well, but in software that has no tamper-resistance safeguard. In this example, only AES decryption is performed at the security level 3, while all other decryption algorithms are implemented using the minimum security level 0. Various security levels will be defined below.

But it is also possible to implement a client device that has a security chip with the firmware that can be upgraded using authenticated firmware download. This same security chip can also perform software integrity verification for the firmware that is executing outside of this security chip. In this case, the decryption component for all decryption algorithms qualifies for at least security level 2.

A security level is defined for each of the security components listed in Table 1. An exemplary list of security levels is provided in Table 2. It should be noted that the listing is illustrative of the present invention. Any number of security levels can be deployed in accordance with the requirements of a particular implementation.

TABLE 2

| Security | |
|---|---|
| Level | Description |
| 0 | No tamper resistance. This security level is assumed by default if |
| | a particular component is not listed in a certificate. |
| 1 | Tamper-resistant, obfuscated software. Software mechanisms |
| | are used to ensure that the code cannot be easily modified or |
| | stepped-through and reverse-engineered using standard software |
| | debugging tools. |
| 2 | Hardware-based protection. Hardware-based protection that |
| | makes it difficult to monitor or modify code and data. Part of the |
| | relevant device component may be executed directly inside a |
| | secure hardware module. The remainder of this component may |
| | be executed in software or in a different hardware module, but |
| | the integrity of these software and hardware modules must be |
| | monitored and validated by a secure hardware module. Once the |
| | integrity of the device component had been violated, its |
| | functionality will be disabled. |
| 3 | Secure hardware subsystem. The relevant component is |
| | executed strictly inside secure hardware module(s). It is |
| | acceptable to have multiple secure hardware modules involved in |
| | the implementation of a single device component, as long |
| | as they communicate via secure tunnels. |

Security components within a client device that implement a security function at a security level that is higher than 0 are required to communicate with other such components within the same device using a cryptographically protected interface. If such an interface between security components includes passing of cryptographic keys, that interface must be encrypted. If the interface carries content usage rules, then message integrity must be cryptographically enforced.

For example, consider a client device that includes an IEEE 1394 digital compressed output that is protected with Dynamic Tunnel Configuration Protocol (DTCP). In this client device, key management and validation of content rules is performed inside a security processor, while DTCP is implemented inside a separate IEEE 1394 chip. For all non-copy-free content displayed via the IEEE 1394 interface, in order to claim a security level greater than 0, the interface between the security processor and the IEEE 1394 chip must be cryptographically protected (e.g., using a Message Authentication Code (MAC)).

Once the security components have been configured and an appropriate security level has been assigned to each of the security components, the client device can be used to process received content. In other words, one or more of the functional security components (listed in Table 1) may be accessed to check for a security level (listed in Table 2) for each granted right associated with the received content. Table 3 below illustrates various security components that may be needed for various granted rights. Again Table 3 is only illustrative of the various granted rights for a received content and is not intended to restrict the present invention to these illustrative examples.

TABLE 3

| | | Functional Security Components |
|---|---|---|
| Granted Right | Conditions | Checked for Security Level |
| Play | | Key Management and RMPI |
| Analog Export | | Enforcement |
| Digital Export SD | | Content encryption/decryption (when |
| Digital Export HD | | content is decrypted or re-encrypted) |
| Extend Rights | | Content decoding (only at the time of |
| | | rendering or decompression for export |
| | | to a legacy interface). |
| | | Content encoding (applicable only at the |
| | | time that the content is being |
| | | transcoded) |
| | Limited | Secure Clock |
| | duration | |
| | for each | |
| | playback. | |
| | Content | Secure Time Of Day |
| | expiration | |
| | time | |

Table 3 above provides a list of possible granted rights associated with the received contents. In certain scenarios, there are additional conditions that are associated with the granted rights. Table 3 illustrates how various security components need to be checked for proper security level for enforcement of each granted right and associated condition(s). It should be noted that there can be additional conditions associated with a granted right that require security level checking for additional components. For each condition listed in the Table 3, security level checking has to be performed both on the components listed for that condition and on the components listed for the associated granted right.

In one embodiment, a client device capable of persistently saving content should not obtain decryption keys if the client device does not satisfy security level requirements as defined in the Table 3.

In one embodiment, it should not be necessary to get an explicit permission to transcode particular content, as long as it can be performed at a sufficient security level for that content. Content trans-coding (i.e., decompression and re-compression using a different codec) may be necessary in order to render content on a device that does not support the original codec format.

Before content decryption key(s) are made available to a specific client device, the source device (e.g., the content provider) has to verify that the target client device can perform key management and DRM enforcement at a specified security level. Then, the target client device can be trusted to validate any other rules associated with the content (e.g., security level for secure clock and so on). Optionally, the source device could validate all of the content rights before passing them along with the content decryption key(s) to the destination client device.

In some cases, a client device is not capable of evaluating DRM rules, but because it is a render-only device it can still satisfy the first security component listed in Table 1. In those cases the source device must validate all the content rights (e.g., expiration time) before providing content decryption keys to the target client device.

In other cases, a client device is capable of evaluating DRM rules, but a security level of a particular component is insufficient for some specific content. If this client device then received the original DRM rules from the content source, the client device would correctly determine that it is not authorized to access this content. In order to enable the client device to consume that content, the content source may reduce the set of DRM rules and pass the reduced set to the client device, where the reduced set now can pass the security level checking.

As an example, DRM rules may allow for content to be stored and played back for 1 week and they also allow rendering the content over protected analog or digital outputs with no copies being made. The client device however is not capable of keeping secure time at a sufficiently high security level and thus cannot store or render this content with the said DRM rules. The content source in this case may edit the DRM rules to allow only rendering over protected analog or digital outputs with no copies being made. Now, the client device can receive and render the content over analog or digital output, without the ability to keep the content persistently.

In one embodiment, client device security capabilities can be specified inside an existing certificate, e.g., an X.509 version 3 certificate extension called certificatePolicies. This extension is defined in ASN.1 as follows:

certificatePolicies ::= SEQUENCE SIZE (1..MAX) OF PolicyInformation
PolicyInformation ::= SEQUENCE {
policyIdentifier CertPolicyId,
policyQualifiers SEQUENCE SIZE (1..MAX) OF PolicyQualifierInfo
OPTIONAL }
CertPolicyId ::= OBJECT IDENTIFIER
PolicyQualifierInfo ::= SEQUENCE {

policyQualifierId PolicyQualifierId,
qualifier ANY DEFINED BY policyQualifierId }

In one embodiment, the certificatePolicies ASN.1 sequence can be adapted to have a separate element representing a security level of each separate device security component. If a security level of a particular security component is not included, security level of 0 is assumed for that security component.

The values of policy OIDs (Object Identifiers) used to identify a device security level are located under the following node:
tvaSecurityLevel=tv-anytime-baseline-rmp securityLevel(1)

Table 4 below provides a list of device security components and their corresponding object identifiers and policy qualifier information. Again, Table 4 is only illustrative and should not be interpreted as a limitation to the present invention.

TABLE 4

| Security Component | OID | PolicyQualifierInfo |
|---|---|---|
| Key Management | tvaKM_RMPI.<level> | None |
| and RMPI | | |
| Enforcement | | |
| Content | tvaEncrypt.<level> | A sequence of OIDs that |
| encryption/ | | correspond to |
| decryption | | cryptographic algorithms |
| | | supported at this security |
| | | level. Each cryptographic |
| | | algorithm could in the |
| | | future have parameters |
| | | defined. |
| Secure Clock | tvaSecureClock.<level> | None |
| Secure Time Of Day | tvaSecureTOD.<level> | None |
| Content Decoding | tvaDecode.<level> | A sequence of OIDs that |
| | | correspond to codecs |
| | | supported at this security |
| | | level. Some codecs may |
| | | have parameters defined. |
| Content Encoding | tvaEncode.<level> | Same as above. |

In Table 4, the parameter <level> is replaced by the security level 0-3. For example, the OID tvaKM_RMPI.2 specifies that Key Management and RMPI Enforcement component is at security level 2. The OIDs listed in the above table are defined as follows:

| | |
|---|---|
| tvaKM_RMPI = | tvaSecurityLevel KM_RMPI(1) |
| tva Encrypt = | tvaSecurityLevel encrypt(2) |
| tvaSecureClock = | tvaSecurityLevel secureClock(3) |
| tvaSecureTOD = | tvaSecurityLevel secureTOD(4) |
| tvaDecode = | tvaSecurityLevel decode(5) |
| tvaEncode = | tvaSecurityLevel encode(6) |

In one embodiment, the following OIDs are defined for cryptographic encryption algorithms that would be listed as a policy qualifier for a Content Encryption/Decryption device component security level:

| | |
|---|---|
| tvaCryptoAlgorithms = | tv-anytime-baseline-rmp cryptoAlgorithms(2) |
| tvaAllAlgorithms = | tvaCryptoAlgorithms All(0) |
| tvaAES = | tvaCryptoAlgorithms AES(1) |
| tvaCamellia = | tvaCryptoAlgorithms Camellia(2) |
| tvaCSAv1 = | tvaCryptoAlgorithms CSAv1(3) |
| tvaCSAv2 = | tvaCryptoAlgorithms CSAv2(4) |
| tva3DES = | tvaCryptoAlgorithms 3DES(5) |
| tvaM2 = | tvaCryptoAlgorithms M2(6) |

The OIDs and associated parameters for the various codecs need to be present as parameters for the Content Encoding and Decoding device components.

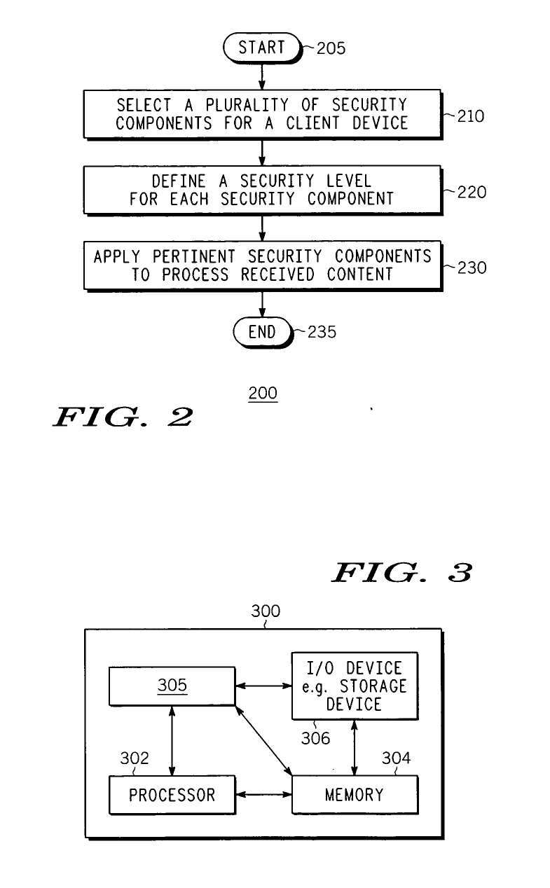

FIG. 2 illustrates a method 200 for providing a security profile that defines a separate security level for each security component within a client device in accordance with the present invention. Method 200 starts in step 205 and proceeds to step 210.

In step 210, method 200 selects a plurality of security components for a client device. Namely, any number of security components, for example as listed in Table 1, can be deployed in a client device. These security components can be defined and implemented when the client device is manufactured or subsequently added, e.g., by downloading software or firmware into the client device.

In step 220, method 200 defines a security level for each of the security components. Namely, any one of the security levels, for example as listed in Table 2, can be defined for a security component.

In step 230, once the client device is configured, one or more of the security components can be applied to process received content to check and/or enforce DRM rules and conditional access. Namely, digital content is received from a content provider and the client device must determine whether the level of security as defined for pertinent security components will satisfy the requirement of DRM rules and/or conditional access associated with the received content. If the client device satisfies the security requirements, the received content will be processed accordingly, e.g., rendered and/or stored in a persistent storage. It should be noted that in one embodiment, one or more certificates that reflect the security level of the client device can be optionally forwarded to the content provider prior to the transmission of the digital content. This approach will allow the content provider to ascertain whether the target client device has the proper level of security to receive the digital content. The Method 200 ends in step 235.

FIG. 3 is a block diagram of the present client device being implemented with a general purpose computer. In one embodiment, the client device 300 is implemented using a general purpose computer or any other hardware equivalents. For example, client device 300 can be broadly implemented as a receiver 140a, a set top box 140b of FIG. 1, an MP3 player, and the like. More specifically, the client device 300 comprises a processor (CPU) 302, a memory 304, e.g., random access memory (RAM) and/or read only memory (ROM), one or more security components 305 as described above (e.g., a key/certificate management component, a content encryption/decryption component, a secure clock component, a secure time of day component, a content decoding component, a content encoding component, and the like), and various input/output devices 306 (e.g., storage devices, including but not limited to, a tape drive, a floppy drive, a hard disk drive or a compact disk drive, a receiver, a decoder, a decryptor, a transmitter, a clock, a speaker, a display, an output port, a user input device (such as a keyboard, a keypad, a mouse, and the like), or a microphone for capturing speech commands).

It should be understood that the one or more security components 305 can be implemented as a physical device or subsystem that is coupled to the CPU 302 through a communication channel. Alternatively, the one or more security components 305 can be represented by one or more software applications or obfuscated software applications (or even a combination of software and hardware, e.g., using application specific integrated circuits (ASIC)), where the software is loaded from a storage medium (e.g., a magnetic or optical drive or diskette) and operated by the CPU in the memory 304 of the computer. As such, the one or more security components 305 (including associated data structures and methods employed within the encoder) of the present invention can be stored on a computer readable medium or carrier, e.g., RAM memory, magnetic or optical drive or diskette and the like.

While the foregoing is directed to embodiments of the present invention, other and further embodiments of the invention may be devised without departing from the basic scope thereof, and the scope thereof is determined by the claims that follow.

1. A method for describing a security level of a client device, comprising:
defining a plurality of security components; and
assigning a security level from a plurality of security levels for each of said plurality of security components.

2. The method of claim 1, wherein said plurality of security components comprises at least two of: a key management and digital rights management (DRM) enforcement component, a content encryption/decryption component, a secure clock component, a secure time of day component, a content decoding component, and a content encoding component.

3. The method of claim 1, further comprising:
receiving a digital content with associated digital rights management (DRM) rules or conditional access; and
applying at least one of said plurality of security components to determine whether said client device is able to comply with said digital rights management (DRM) rules or conditional access.

4. The method of claim 1, further comprising:
generating at least one certificate that is representative of a security profile of said client device.

5. The method of claim 4, further comprising:
forwarding said at least one certificate to a content provider.

6. The method of claim 1, wherein said plurality of security levels comprise at least two of: a no tamper resistance level, a tamper-resistant obfuscated software level, a hardware-based protection level, and a secure hardware subsystem level.

7. The method of claim 1, further comprising:
receiving a digital content from a content source, where said content source has determined that said client device has a sufficient security level for a key management and digital rights management (DRM) enforcement component, and where said client device is trusted to validate one or more DRM rules and to apply one or more of said plurality of security components to said digital content.

8. The method of claim 1, further comprising:
receiving a digital content from a content source, where said content source has determined that said client device has a sufficient security level for all of said plurality of security components before said digital content is sent to said client device.

9. A computer-readable carrier having stored thereon a plurality of instructions, the plurality of instructions including instructions which, when executed by a processor, cause the processor to perform the steps of a method for describing a security level of a client device, comprising of:
defining a plurality of security components; and
assigning a security level from a plurality of security levels for each of said plurality of security components.

10. The computer-readable carrier of claim 9, wherein said plurality of security components comprises at least two of: a key management and digital rights management (DRM) enforcement component, a content encryption/decryption component, a secure clock component, a secure time of day component, a content decoding component, and a content encoding component.

11. The computer-readable carrier of claim 9, further comprising:
receiving a digital content with associated digital rights management (DRM) rules or conditional access; and
applying at least one of said plurality of security components to determine whether said client device is able to comply with said digital rights management (DRM) rules or conditional access.

12. The computer-readable carrier of claim 9, further comprising:
generating at least one certificate that is representative of a security profile of said client device.

13. The computer-readable carrier of claim 12, further comprising:
forwarding said at least one certificate to a content provider.

14. The computer-readable carrier of claim 9, wherein said plurality of security levels comprise at least two of: a no tamper resistance level, a tamper-resistant obfuscated software level, a hardware-based protection level, and a secure hardware subsystem level.

15. A client device, comprising:
means for defining a plurality of security components; and
means for assigning a security level from a plurality of security levels for each of said plurality of security components.

16. The client device of claim 15, wherein said plurality of security components comprises at least two of: a key management and digital rights management (DRM) enforcement component, a content encryption/decryption component, a secure clock component, a secure time of day component, a content decoding component, and a content encoding component.

17. The client device of claim 15, further comprising:
means for receiving a digital content with associated digital rights management (DRM) rules or conditional access; and
means for applying at least one of said plurality of security components to determine whether said client device is able to comply with said digital rights management (DRM) rules or conditional access.

18. The client device of claim 15, further comprising:
means for generating at least one certificate that is representative of a security profile of said client device; and
means for forwarding said at least one certificate to a content provider.

19. The client device of claim 15, wherein said plurality of security levels comprise at least two of: a no tamper resistance level, a tamper-resistant obfuscated software level, a hardware-based protection level, and a secure hardware subsystem level.

20. The client device of claim 15, further comprising:
means for receiving a digital content from a content source, where said content source has determined that said client device has a sufficient security level for a key management and digital rights management (DRM) enforcement component, and where said client device is trusted to validate one or more DRM rules and to apply one or more of said plurality of security components to said digital content.
